(19) United States
(12) Patent Application Publication
(10) Pub. No.: US 2012/0061122 A1
(43) Pub. Date: Mar. 15, 2012

(54) CONDUCTOR FOR ELECTRIC WIRE, AND ELECTRIC WIRE FOR AUTOMOBILE

(75) Inventors: Hiroyuki Kodama, Yokkaichi-shi (JP); Yasuyuki Otsuka, Yokkaichi-shi (JP); Misato Kusakari, Osaka-shi (JP); Taichirou Nishikawa, Osaka-shi (JP)

(73) Assignees: AUTONETWORKS TECHNOLOGIES, LTD., Yokkaichi-shi, Mie (JP); SUMITOMO ELECTRIC INDUSTRIES, LTD., Osaka-shi, Osaka (JP); SUMITOMO WIRING SYSTEMS, LTD., Yokkaichi-shi, Mie (JP)

(21) Appl. No.: 13/319,867

(22) PCT Filed: Jun. 8, 2010
(86) PCT No.: PCT/JP2010/059641

§ 371 Date: Nov. 10, 2011

(30) Foreign Application Priority Data
Jun. 16, 2009 (JP) 2009-142838

(51) Int. Cl. H01B 5/02

(52) U.S. Cl. 174/126.1

(57) ABSTRACT

A conductor for electric wire that has excellent strength and excellent weldability, and an electric wire for automobile including the conductor. The conductor for electric wire contains a copper alloy having an oxygen content of 50 mass parts per million or less, the copper alloy containing 0.1 to 0.6 mass % Mg, and a balance of copper and an unavoidable impurity. It is preferable that the copper alloy further contains one or a plurality of material elements selected from the group consisting of Ag, In, Sr and Ca, the selected one or plurality of material elements being 0.0005 to 0.3 mass % in total. It is preferable that the copper alloy further contains 0.2 to 0.75 mass % Sn.

### TECHNICAL FIELD

The present invention relates to a conductor for electric wire, and an electric wire for automobile, and more specifically relates to a conductor for electric wire suitably used as a conductor for reduced-diameter electric wire, and an electric wire for automobile including the same.

### BACKGROUND ART

Conventionally, a conductor for electric wire used for automobile is widely known, which is made from an annealed material of tough pitch copper (hereinafter, referred to as an “annealed copper”). In addition, a conductor is widely known, which consists of a plurality of conductor members including a SUS wire, which is placed at the center of the conductor as a tension member, and annealed copper elemental wires, which are placed around the SUS wire (hereinafter, the conductor is sometimes referred to simply as a (SUS+annealed copper) conductor).

PTL1 that is a prior art discloses a conductor for electric wire made from a copper alloy that is a Cu—Mg—Sn alloy containing 0.1 wt % to 0.6 wt % Sn and 0.1 wt % to 0.5 wt % Mg.

PTL2 that is a prior art discloses a conductor for electrical/electronic appliance made from a copper alloy that contains Cu, Mg, which have oxygen contents at a weight ratio of 50 ppm or less to 11-200 ppm, and one or two kinds of material elements selected from the group consisting of In and Sn, the one or two kinds of the selected material elements being 0.1 wt % to 1.0 wt % in total.

### CITATION LIST

### Patent Literature

PTL1: JP H09-511867 W

PTL2: JP H06-240388 A

### SUMMARY OF INVENTION

### Technical Problem

However, the conventional conductor for electric wire made from the annealed copper, and the conventional (SUS+annealed copper) conductor have problems as follows.

Generally in the automobile field, a plurality of electric wires each including the conductors as described above are bunched into a wire harness, and used in the form of the wire harness. Nowadays, enhancement of performance of automobiles increases the number of electrical components required for the automobiles, which accordingly increases the number of electric wires used to electrically connect the electrical components. In contrast, weight reduction of automobiles is required in consideration of environmental protection, resource saving, and improvement in fuel efficiency, which accordingly requires weight reduction of wire harnesses used in automobiles. One solution to the weight reduction of wire harnesses is to reduce the diameters of the conductors that make up the wire harnesses.

However, a problem arises in using conventional conductors made from an annealed copper because when reduced in diameter, the conductors are reduced in strength.

In addition, another problem arises. In providing a branch to a wire harness circuit, a splice is made in electric wires of the wire harness such that the electric wires are partially welded to establish mechanical electrical connection among them; however, a SUS wire of a (SUS+annealed copper) conductor placed at the center of the conductor could be partially exposed on the conductor surface. Consequently, when (SUS+annealed copper) conductors are welded, or when a (SUS+annealed copper) conductor and a conductor made from an annealed copper are welded, the dissimilar metals of copper and SUS could be welded, which makes it difficult to provide mechanical electrical connection between them. In addition, there is another problem that a (SUS+annealed copper) conductor has fatigue resistance inferior to a conductor made from an annealed copper.

The present invention has been made in view of the problems described above, and an object of the present invention is to overcome the problems and to provide a conductor for electric wire that has excellent strength and excellent weldability, and an electric wire for automobile including the conductor.

### Solution to Problem

To achieve the objects and in accordance with the purpose of the present invention, a conductor for electric wire contains a copper alloy having an oxygen content of 50 mass parts per million or less, the copper alloy containing 0.1 to 0.6 mass % Mg, and a balance of copper and an unavoidable impurity.

In another aspect of the present invention, a conductor for electric wire contains a copper alloy having an oxygen content of 50 mass parts per million or less, the copper alloy containing 0.1 to 0.6 mass % Mg, one or a plurality of material elements selected from the group consisting of Ag, In, Sr and Ca, the selected one or plurality of material elements being 0.0005 to 0.3 mass % in total, and a balance of copper and an unavoidable impurity.

In another aspect of the present invention, a conductor for electric wire contains a copper alloy having an oxygen content of 50 mass parts per million or less contains 0.1 to 0.6 mass % Mg, 0.2 to 0.75 mass % Sn, and a balance of copper and an unavoidable impurity.

In another aspect of the present invention, a conductor for electric wire contains a copper alloy having an oxygen content of 50 mass parts per million or less, the copper alloy containing 0.1 to 0.6 mass % Mg, one or a plurality of material elements selected from the group consisting of Ag, In, Sr and Ca, the selected one or plurality of material elements being 0.0005 to 0.3 mass % in total, 0.2 to 0.75 mass % Sn, and a balance of copper and an unavoidable impurity.

It is preferable that the conductors described above have a tensile strength of 350 MPa or more.

It is preferable that the conductors described above have a cross-sectional area of 0.22 mm² or less.

It is preferable that the conductors described above include conductors for electric wire that are used for automobile.

In another aspect of the present invention, an electric wire for automobile includes any one of the conductors described above.

### Advantageous Effects of Invention

Containing the copper alloy that has the specific amount or less of oxygen content and contains the specific amount of Mg, each conductor according to the preferred embodiments of the present invention has tensile strength more excellent than an annealed copper. Consequently, the conductors according to the preferred embodiments of the present invention do not need to have their strength secured, which is secured in a (SUS+annealed copper) conductor by combining dissimilar metals, thus each conductor according to the preferred embodiments of the present invention has excellent weldability. In addition, each conductor according to the preferred embodiments of the present invention has favorable fatigue resistance, and accordingly has excellent flex resistance. Thus, if used as conductors for electric wire used for automobile, for example, the conductors can be reduced in diameter, which can contribute to diameter reduction of electric wires, and weight reduction of wire harnesses.

If each copper alloy contains the specific amount of one or the plurality of material elements selected from the group consisting of Ag, In, Sr and Ca, each conductor can have favorably improved strength. In addition, each conductor can have improved fatigue resistance, which can enhance the improvement of flex resistance.

If each copper alloy contains the specific amount of Sn, each conductor can have an improved elongation property in addition to favorably improved strength.

If each conductor contains the copper alloy having the tensile strength of 350 MPa or more, the conductors can be reduced in diameter, which can more easily achieve diameter reduction of electric wires and weight reduction of wire harnesses.

Because the electric wire for automobile according to the preferred embodiment of the present invention includes any one of the conductors described above, even if the conductor is reduced in diameter, reduction in strength or in weldability of the conductor due to the reduced-diameter is not easily made, while such reduction in strength or in weldability is made in a conventional conductor. Thus, the conductors can contribute to weight reduction of wire harnesses.

### BRIEF DESCRIPTION OF DRAWINGS

FIG. 1 is a view illustrating a method for testing flex resistance in Example.

### DESCRIPTION OF EMBODIMENTS

Detailed descriptions of a conductor for electric wire according to one of preferred embodiments of the present invention (hereinafter, referred to as the “present conductor”), and an electric wire for automobile including the conductor (hereinafter, referred to as the “present electric wire”) will now be provided.

1. Present Conductor

The present conductor contains a copper alloy that has a specific amount or less of oxygen content, and contains specific amounts of material elements, and a balance of copper and an unavoidable impurity. The kinds of the contained material elements, the contents thereof, and reasons to limit the contents are described below.
Mg: 0.1 to 0.6 mass %

The copper alloy contained in the present conductor contains 0.1 to 0.6 mass % Mg in view of providing the conductor with strength and weldability. The lower limit of the Mg content is preferably 0.15 mass % in view of improving the strength and weldability. On the other hand, the upper limit of the Mg content is preferably 0.4 mass % in view of improving the weldability.

The copper alloy contained in the present conductor may contain, in addition to Mg, the following material elements singly or in combination.
One or a plurality of material elements selected from the group consisting of Ag, In, Sr and Ca: 0.0005 to 0.3 mass % in total

The copper alloy contained in the present conductor may further contain one or a plurality of material elements selected from the group consisting of Ag, In, Sr and Ca, the selected one or plurality of material elements being 0.0005 to 0.3 mass % in total in view of favorably improving the strength and enhancing the improvement of flex resistance of the conductor. The lower limit of the content of the selected one or plurality of material elements is preferably 0.0008 mass % in total, more preferably 0.001 mass % in total. On the other hand, the upper limit of the content of the selected one or plurality of material elements is preferably 0.2 mass %, more preferably 0.1 mass % in view of conductor cost and production workability.
Sn: 0.2 to 0.75 mass %

The copper alloy contained in the present conductor may further contain 0.2 to 0.75 mass % Sn in view of favorably improving the strength and enhancing the improvement of the flex resistance. The lower limit of the content of the selected one or plurality of material elements is preferably 0.0008 mass % in total, more preferably 0.001 mass % in total. On the other hand, the upper limit of the content of the selected one or plurality of material elements is preferably 0.2 mass %, more preferably 0.1 mass % in view of conductor cost and production workability.

The copper alloy contained in the present conductor has an oxygen content of 50 mass parts per million or less. This is because if the oxygen content is over 50 mass parts per million, the dissolved magnesium in the copper alloy is precipitated as magnesium oxide, which greatly reduces the strength of the conductor. The upper limit of the oxygen content is preferably 30 mass parts per million or less, more preferably 20 mass parts per million or less, still more preferably 10 mass parts per million or less in view of improving the strength of the conductor. The lower limit of the oxygen content is not limited specifically because the less oxygen content is preferable; however, completely removing oxygen from the copper alloy could cause an increase in production cost. Thus, the lower limit of the oxygen content is preferably 5 mass parts per million or less in view of production cost.

The present conductor described above preferably has a tensile strength of 350 MPa or more. This is because if the tensile strength is 350 MPa or more, the conductors can be reduced in diameter, which can more easily achieve diameter reduction of an electric wire and weight reduction of a wire harness. The tensile strength is more preferably 400 MPa, still more preferably 450 MPa.

The present conductor has a cross-sectional area that is preferably 0.22 mm² or less, more preferably 0.05 to 0.15 mm² in view of weight reduction and reduction of a routing space of a wire harness, which is favorably used for an electric wire for automobile.

The present conductor may have a configuration of a single core wire of an elemental wire made from the copper alloy described above, or a configuration of a stranded wire of elemental wires made from the copper alloy described above. In using the conductor of the stranded wire, it may be compressed concentrically.

The copper alloy described above may be subjected to an annealing process in view of improving ability of a harness to be assembled and an elongation property of the conductor. The temperature of the annealing process is preferably 200 to 500° C. The method for the annealing process is preferably continuous annealing by the passage of electric current, continuous annealing by high-frequency induction heating, or batch annealing using a box furnace, which is not limited specifically.

2. Present Electric Wire

The present electric wire includes the present conductor. Specific configuration examples of the present electric wire include a configuration that the present electric wire includes the present conductor, and a single-layered or two-layered insulator with which the conductor is covered. The insulator may be covered with a shielded conductor such as a braid and a metallic foil.

The insulator is made from an insulation material, which is not limited specifically. Examples of the insulation material include a non-halogenous material such as a homopolymer of olefin such as ethylene and propylene, an ethylene-alpha-olefin copolymer, a copolymer of olefin and ethylene-(meth)acrylic ester, and a copolymer of olefin and vinyl acetate, and a halogenous material such as a vinyl chloride resin. A variety of additives may be added to the insulation material in addition to the resin material.

The use of the present electric wire is not limited specifically; however, the present electric wire is used preferably as a signal wire.

### EXAMPLES

A detailed description of the present invention will now be provided with reference to Examples. It is to be noted that the present invention is not limited thereto.

1. Preparation of Conductors for Electric Wire According to Examples and Comparative Examples

Each of conductors for electric wire according to Examples and Comparative Examples was prepared by stranding seven elemental wires that are made from the alloy material elements and have the diameters shown in Tables 1 and 2.

2. Evaluation

The prepared conductors were measured to obtain breaking loads, tensile strengths, ultrasonic weldability and flex resistances in the measurement methods as follows.

(Measurement of Breaking Loads and Tensile Strengths)

Each of the prepared conductors was stretched using a tensile strength tester, and a maximum load applied to each conductor when each conductor is broken was measured as a breaking load. Then, by dividing a value of the obtained breaking load of each conductor by a value of cross-sectional area of each conductor, a tensile strength [MPa] of each conductor was obtained (i.e., a tensile strength [MPa]=a breaking load [N]/a cross-sectional area [mm²]).

(Ultrasonic Weldability)

The conductors of the same kind were ultrasonic welded, and a cross section of a welded portion of the conductors of the same kind was observed. The conductors of the same kind whose cross section of the space between the elemental wires was less than 10% of the cross section of all the conductors of the same kind were evaluated as “excellent” in ultrasonic weldability. The conductors of the same kind whose cross section of the space between the elemental wires was 10 to 20% of the cross section of all the conductors of the same kind were evaluated as “favorable” in ultrasonic weldability. The conductors of the same kind whose cross section of the space between the elemental wires was more than 20% of the cross section of all the conductors of the same kind were evaluated as “unfavorable” in ultrasonic weldability.

(Flex Resistances)

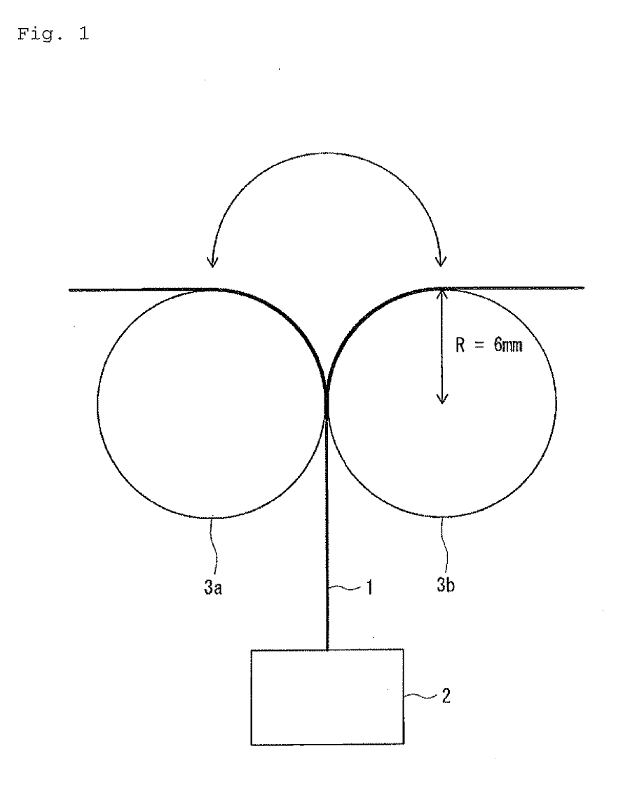

As shown in FIG. 1, one end of a conductor 1 for electric wire of 300 mm long was fixed to a rotating arm (not shown), a weight 2 (250 g) was hung with the other end of the conductor 1, and the conductor 1 was supported at a middle point in a longitudinal direction thereof between a pair of columnar members 3a and 3b (each having a radius R of 6 mm). Then, the rotating arm was rotated 90 degrees in one direction and 90 degrees in the other direction so that the conductor 1 went around the perimeters of the columnar members 3a and 3b, and the conductor 1 was repeatedly flexed at the radius R so as to reciprocate at a speed of 60 times/minute. The number of reciprocation before the conductor 1 was broken through the test for flex resistance described above was counted.

It is to be noted that the test for flex resistance was made in order to investigate a fatigue property of each conductor.

TABLE 1

| | | | Example | | | | | | | | | | | |
|---|---|---|---|---|---|---|---|---|---|---|---|---|---|---|
| | | | 1 | 2 | 3 | 4 | 5 | 6 | 7 | 8 | 9 | 10 | 11 | 12 |
| Copper | Mg | Mass % | 0.2 | 0.4 | 0.2 | 0.2 | 0.2 | 0.2 | 0.2 | 0.2 | 0.2 | 0.2 | 0.2 | 0.2 |
| Alloy | Ag | Mass % | — | — | 0.001 | — | — | — | 0.1 | — | — | — | — | 0.001 |
| Com- | In | Mass % | — | — | — | 0.001 | — | — | — | 0.1 | — | — | — | — |
| position | Sr | Mass % | — | — | — | — | 0.001 | — | — | — | 0.1 | — | — | — |
| | Ca | Mass % | — | — | — | — | — | 0.001 | — | — | — | 0.1 | — | — |
| | Sn | Mass % | — | — | — | — | — | — | — | — | — | — | 0.3 | 0.3 |
| | O₂ | ppm | 8 | 8 | 8 | 8 | 8 | 8 | 8 | 8 | 8 | 8 | 8 | 8 |
| | Cu | Mass % | bal | bal | bal | bal | bal | bal | bal | bal | bal | bal | bal | bal |

| Elemental | mm | 0.15 | 0.15 | 0.15 | 0.15 | 0.15 | 0.15 | 0.15 | 0.15 | 0.15 | 0.15 | 0.15 | 0.15 |
|---|---|---|---|---|---|---|---|---|---|---|---|---|---|
| Wire | | | | | | | | | | | | | |
| Diameter | | | | | | | | | | | | | |
| Conductor | nm² | 0.13 | 0.13 | 0.13 | 0.13 | 0.13 | 0.13 | 0.13 | 0.13 | 0.13 | 0.13 | 0.13 | 0.13 |
| Cross- | | | | | | | | | | | | | |
| Sectional | | | | | | | | | | | | | |
| Area | | | | | | | | | | | | | |
| Breaking | N | 105 | 112 | 107 | 106 | 106 | 107 | 130 | 119 | 117 | 118 | 136 | 136 |
| Load (Max) | | | | | | | | | | | | | |
| Tensile | MPa | 808 | 862 | 823 | 815 | 815 | 823 | 1000 | 915 | 900 | 908 | 1046 | 1046 |
| Strength | | | | | | | | | | | | | |
| Ultrasonic Weldability | | Favor- | Favor- | Favor- | Favor- | Favor- | Favor- | Favor- | Favor- | Favor- | Favor- | Favor- | Favor- |
| | | able | able | able | able | able | able | able | able | able | able | able | able |
| Flex | Number | 1580 | 1620 | 1740 | 1700 | 1620 | 1650 | 2010 | 1750 | 1810 | 1760 | 2230 | 2150 |
| Resistance | of | | | | | | | | | | | | |
| | Recipro- | | | | | | | | | | | | |
| | cation | | | | | | | | | | | | |

TABLE 2

| | | | Comparative Example | | | | | | |
|---|---|---|---|---|---|---|---|---|---|
| | | | 1 | 2 | 3 | 4 | 5 | 6 | 7 |
| [symbol] | Mg | Mass % | — | — | 0.7 | 0.2 | 0.2 | 0.2 | 0.2 |
| | Ag | Mass % | — | — | — | — | — | 0.5 | 0.1 |
| | In | Mass % | — | — | — | — | — | — | 0.1 |
| | Sr | Mass % | — | — | — | — | — | — | 0.1 |
| | Ca | Mass % | — | — | — | — | — | — | 0.1 |
| | Sn | Mass % | — | — | — | — | — | — | — |
| | O₂ | ppm | 300 | 300 | 8 | 300 | 100 | 8 | 8 |
| | Cu | Mass % | bal | bal | bal | bal | bal | bal | bal |

| Elemental Wire | mm | 0.25 | 0.15 | 0.15 | 0.15 | 0.15 | 0.15 | 0.15 |
|---|---|---|---|---|---|---|---|---|
| Diameter | | | | | | | | |
| Conductor Cross- | mm² | 0.35 | 0.13 | 0.13 | 0.13 | 0.13 | 0.13 | 0.13 |
| Sectional Area | | | | | | | | |
| Breaking Load (Max) | N | 84 | 31 | 114 | 77 | 78 | 129 | 125 |
| Tensile Strength | MPa | 240 | 238 | 877 | 592 | 600 | 992 | 962 |
| Ultrasonic Weldability | | Excellent | Excellent | Unfavorable | Unfavorable | Unfavorable | Unfavorable | Unfavorable |
| Flex Resistance | Number of | 570 | 1250 | 2100 | 950 | 1100 | 1920 | 1850 |
| | Reciprocation | | | | | | | |

[symbol]

indicates data missing or illegible when filed

3. Consideration

According to the results shown in Tables 1 and 2, it is found that the conductors for electric wire according to Comparative Examples 1 and 2 that are made from the annealed coppers have the low strengths. Thus, if reduced in diameter, the conductors are reduced in strength, accordingly. For this reason, the conductors are unfavorable for diameter reduction.

It is found that the conductor for electric wire according to Comparative Example 3 is inferior in weldability because the Mg content is more than the upper limit defined in the present invention, while having the excellent strength and flex resistance.

It is found that the conductors for electric wire according to Comparative Examples 4 and 5 have the poor strengths because the oxygen contents are more than the upper limit defined in the present invention. This is considered because the magnesium oxide is easily generated when the oxygen contents are high, which prevents the effect of improving the strengths of the conductors.

It is found that the conductors for electric wire according to Comparative Examples 6 and 7 are inferior in weldability because the Ag, In, Sr and Ca contents are more than the upper limit defined in the present invention.

In contrast, the conductors for electric wire according to present Examples have the high tensile strengths. In addition, the conductors for electric wire according to present Examples are excellent in weldability because they do not need to have their strength secured by combining dissimilar metals and are thus free from dissimilar metal combination while the strength needs to be secured in a (SUS+annealed copper) conductor by combining dissimilar metals. In addition, the conductors for electric wire according to present Examples each have the favorable fatigue resistances, and accordingly have the excellent flex resistances. Thus, if used as conductors for electric wire used for automobile, for example, the conductors can be reduced in diameter, which can contribute to diameter reduction of electric wires, and weight reduction of wire harnesses.

The foregoing description of the preferred embodiments of the present invention has been presented for purposes of illustration and description; however, it is not intended to be exhaustive or to limit the present invention to the precise form disclosed, and modifications and variations are possible as long as they do not deviate from the principles of the present invention.

1-8. (canceled)

9. A conductor for electric wire, the conductor containing
a copper alloy having an oxygen content of 50 mass parts per million or less, the copper alloy containing:
0.1 to 0.6 mass % Mg; and
a balance of copper and an unavoidable impurity.

10. The conductor according to claim 9, wherein the conductor has a tensile strength of 350 MPa or more.

11. The conductor according to claim 9, wherein the conductor has a cross-sectional area of 0.22 mm² or less.

12. The conductor according to claim 9, wherein the conductor comprises a conductor for electric wire that is used for automobile.

13. A conductor for electric wire, the conductor containing
a copper alloy having an oxygen content of 50 mass parts per million or less, the copper alloy containing:
0.1 to 0.6 mass % Mg;
one or a plurality of material elements selected from the group consisting of Ag, In, Sr and Ca, the selected one or plurality of material elements being 0.0005 to 0.3 mass % in total; and
a balance of copper and an unavoidable impurity.

14. The conductor according to claim 13, wherein the conductor has a tensile strength of 350 MPa or more.

15. The conductor according to claim 13, wherein the conductor has a cross-sectional area of 0.22 mm² or less.

16. The conductor according to claim 13, wherein the conductor comprises a conductor for electric wire that is used for automobile.

17. A conductor for electric wire, the conductor containing
a copper alloy having an oxygen content of 50 mass parts per million or less, the copper alloy containing:
0.1 to 0.6 mass % Mg;
0.2 to 0.75 mass % Sn; and
a balance of copper and an unavoidable impurity.

18. The conductor according to claim 17, wherein the conductor has a tensile strength of 350 MPa or more.

19. The conductor according to claim 17, wherein the conductor has a cross-sectional area of 0.22 mm² or less.

20. The conductor according to claim 17, wherein the conductor comprises a conductor for electric wire that is used for automobile.

21. A conductor for electric wire, the conductor containing
a copper alloy having an oxygen content of 50 mass parts per million or less, the copper alloy containing:
0.1 to 0.6 mass % Mg;
one or a plurality of material elements selected from the group consisting of Ag, In, Sr and Ca, the selected one or plurality of material elements being 0.0005 to 0.3 mass % in total;
0.2 to 0.75 mass % Sn; and
a balance of copper and an unavoidable impurity.

22. The conductor according to claim 21, wherein the conductor has a tensile strength of 350 MPa or more.

23. The conductor according to claim 21, wherein the conductor has a cross-sectional area of 0.22 mm² or less.

24. The conductor according to claim 21, wherein the conductor comprises a conductor for electric wire that is used for automobile.
